(19) United States
(12) Patent Application Publication
(10) Pub. No.: US 2024/0069607 A1
(43) Pub. Date: Feb. 29, 2024

(54) MEMORY MODULE SOCKET

(71) Applicants: Dong Weon HWANG, Seongnam-si (KR); Logan Jae HWANG, Beverly Hills, CA (US); Jae Baek HWANG, Seoul (KR); HICON CO., LTD., Seongnam-si (KR)

(72) Inventors: Dong Weon HWANG, Seongnam-si (KR); Logan Jae HWANG, Beverly Hills, CA (US); Jae Baek HWANG, Seoul (KR)

(73) Assignees: Dong Weon HWANG, Seongnam-si (KR); Logan Jae HWANG, Beverly Hills, CA (US); Jae Baek HWANG, Seoul (KR); HICON CO., LTD., Seongnam-si (KR)

(21) Appl. No.: 18/447,302

(22) Filed: Aug. 10, 2023

(30) Foreign Application Priority Data
Aug. 31, 2022 (KR) 10-2022-0110282

(51) Int. Cl. G06F 1/18; H01R 12/70; H01R 13/15

(52) U.S. Cl. CPC G06F 1/184; H01R 12/7005; H01R 13/15; H01R 2201/06

(57) ABSTRACT

Proposed is a memory module socket capable of increasing electrical contact reliability. The memory module socket includes a socket body (100) including a slot (111) in which terminals (13) of a memory module are inserted, a plurality of receiving portions (113) symmetrically defined by a plurality of partition walls (112), and a stopper member (114) provided under the slot (111), at least one pair of contacts (200) symmetrically provided in each pair of receiving portions (113); and an elastic body (300) inserted into the socket body (100). Each of the contacts (200) includes a curved portion (210), an outer extension portion (220), a first protrusion (222), an inner extension portion (230), an inclined extension portion (240) including a first contact protrusion (240a), and a vertical extension portion (250). Each of the receiving portions (113) includes restraining surfaces (118a and 118b).

### CROSS REFERENCE TO RELATED APPLICATION

The present application claims priority to Korean Patent Application No. 10-2022-0110282, filed Aug. 31, 2022, the entire contents of which is incorporated herein for all purposes by this reference.

### BACKGROUND OF THE INVENTION

### Field of the Invention

The present disclosure relates to a socket for mounting a memory module to a mother board or a test board of a system.

### Description of the Related Art

In general, a memory module is comprised of a plurality of memory chips mounted on a circuit board, and is used as a main memory of a computer (PC).

FIGS. 1A and 1B are respectively a front view and a side view illustrating a typical memory module 10. The memory module 10 is configured by soldering a memory integrated circuit (IC) 12 to a printed circuit board (PCB) 11, and a plurality of terminals 13 for input and output of signals are longitudinally provided at each side of a lower end of the PCB 11 at regular pitches. The memory module 10 is mounted on a socket of a mother board of a system and is used as a memory device. In addition, the memory module 10 is subjected to various performance tests by test equipment after production. During the testing, the memory module 10 is mounted in a test socket and electrically connected to the test equipment.

FIG. 2 is a sectional view illustrating a memory module test socket 20 according to the related art, and FIG. 3 is a view illustrating a contact 40 illustrated in FIG. 2.

Referring to FIGS. 2 and 3, the test socket 20 according to the related art includes a socket body 30, contacts 40, elastic bodies 50, and a bracket 60.

The socket body 30 has a slot 31 formed in the center thereof to allow the terminals 13 of the memory module 10 to be inserted therein, and a stopper 32 provided under the slot 31 to limit an insertion depth of the memory module 10. A plurality of partition walls 33 are provided at each side of the slot 31, and a plurality of receiving grooves 34 are formed between the partition walls 33. A seating groove is recessed from a lower end of each of the partition walls 33, and each of the elastic bodies 50 is inserted into the respective seating grooves at each side of the slot 31.

Each of the contacts 40 includes a substantially semicircular curved portion 41, a quadrangular fixing protrusion 42 protruding horizontally from a first side of the curved portion 41, a fixing piece 43 extending upwards from the fixing protrusion 42, a moving piece 44 extending from a second side of the curved portion 41, a contact portion 45 bent and extending from the moving piece 44, and a moving protrusion 46 protruding and extending from the contact portion 45.

The bracket 60 is coupled to a lower portion of the socket body 30. The bracket 60 has an opening communicating with two receiving grooves 34 so that a lower portion of the contact 40 protrudes to a lower end of the opening. The bracket 60 has a fixing stepped portion 61 corresponding to a positioning stepped portion 35 formed on the socket body 30 adjacent to the opening. A groove having a predetermined length L1 is formed by the two stepped portions 35 and 61, and the fixing protrusion 42 having a predetermined thickness L2 (L1<L2) is movably inserted into the groove.

In the related-art test socket having the above configuration, the contact 40 is a rigid body that does not have its own elasticity. As the contact 40 itself is rotated when the memory module 10 is inserted, a contact force is generated between a lower end of the curved portion 41 and a pad 70 of a test PCB.

When the memory module test socket performs electrical performance and quality tests, the test speed, whether or not the socket operates normally, sequence flow, contact maintenance, and life cycle determine the performance of the socket. Since the memory module test socket has the characteristics of a consumable with degraded mechanical and electrical properties due to repeated use, the number of times it can be used has a great impact on business possibility. As the Joint Electron Device Engineering Council (JEDEC) has recently announced the publication of DDR5 standard, the memory industry is transitioning from DDR4 to DDR5. This requires a memory module test socket with improved test complexity and speed compared to the related art. The transition from DDR4 to DDR5 memory modules has led to a change in prefetch being doubled from 8n to 16n, which helps double the memory access availability compared to DDR4. Also, DDR5's bandwidth has been increased to 3200 to 8400 MHz by more than twice compared to DDR4's 1500 to 3200 MHz, and an ultra-high frequency of 4800 MHz is expected from early DDR5. Thus, when conventional memory module test sockets are used, a problem arises in that test performance is rapidly degraded.

That is, a new test socket capable of high-speed/large-capacity processing is required for use in testing DDR5 memory modules. In order to meet this demand, the related art described above has proposed a contact structure that secures high-frequency characteristics by minimizing an electrical path. Nevertheless, there are still limitations in meeting the needs of the field in DDR5 testing.

Contacts affect test performance and lifespan since minute design changes in their shape affect the resistance and electrical path of the contacts. Technical issues to meet the test complexity and speed performance of DDR5 can be summarized as follows.

First, it may be considered to improve resistance characteristics excellently by minimizing the volume of a contact body. The above-described contact 40 according to the related art forms an electrical path having a relatively consistent width and volume, but the problem of support and fixation for maintaining a consistent contact force exists. To solve this problem, the fixing protrusion 42 having an asymmetrical shape and a predetermined volume had to be formed. In this point of view, if a pin structure is improved to form an asymmetrical shape and maximum consistent volume while maintaining the fixing force and contact force of the contact, better resistance characteristics will be obtained.

Second, improvement of the terminal contact condition may be considered. In the contact 40 according to the related art, the contact with the terminal is made as a rigid body that does not have its own elasticity is rotated and tilted finely in the receiving groove 34 having a clearance designed for the movement of the contact 40. In this case, if a slight error occurs in the forming of L1 and L2 of the groove of the socket body 30 and the fixing protrusion 42, a defective contact condition may be caused. If the distance between L1 and L2 is formed too large, the contact 40 may not make sufficient contact with the terminal of the memory module. On the other hand, if the distance is formed too small, the contact force with the terminal is too strong, there is a possibility that the rigid contact 40 may cause excessive wear on the terminal.

To overcome the above problems, the present applicant has proposed a contact that is elastically fixed without requiring the use of a separate injection-molded product for fixing, thereby reducing manufacturing costs while having excellent contact conditions, and has also proposed a memory module socket.

The foregoing is intended merely to aid in the understanding of the background of the present disclosure, and is not intended to mean that the present disclosure falls within the purview of the related art that is already known to those skilled in the art.

### Documents of Related Art

(Patent document 1) Korean Patent No. 10-0887936 (published on Mar. 12, 2009)

### SUMMARY OF THE INVENTION

Accordingly, the present disclosure has been made keeping in mind the above problems occurring in the related art, and an objective of the present disclosure is to provide a memory module socket capable of increasing electrical contact reliability and improving electrical characteristics in high-speed signals.

Another objective of the present disclosure is to provide a contact having an elastically fixable structure that improves resistance characteristics by minimizing the volume of a contact body, thereby improving contact conditions and life characteristics at the same time, and to provide a memory module socket including the same.

In order to achieve the above objectives, according to one aspect of the present disclosure, there is provided a memory module socket including: a socket body including a slot configured to allow terminals of a memory module to be inserted therein, a plurality of receiving portions symmetrically defined by a plurality of partition walls at opposite sides of the slot, and a stopper member provided under the slot; at least one pair of contacts symmetrically provided in each pair of receiving portions and configured to electrically connect the terminals and pads of a test PCB; and an elastic body having a circular cross-section and inserted into the socket body to elastically support each of the contacts to the socket body, wherein each of the contacts may include: a curved portion surrounding at least a portion of an outer circumferential surface of the elastic body; an outer extension portion extending from an outside of the curved portion; a first protrusion protruding outwards adjacent to an upper front end of the outer extension portion; an inner extension portion extending from an inside of the curved portion; an inclined extension portion inclinedly extending from the inner extension portion and including a first contact protrusion configured to make contact with a terminal; and a vertical extension portion vertically extending from the inclined extension portion, and each of the receiving portions may include restraining surfaces configured to restrain an initial movement of the first protrusion to elastically compress and support the outer extension portion.

In a preferred embodiment, the curved portion may include a second contact protrusion formed in a curved surface shape at a lower end thereof, and the vertical extension portion may include a tip portion at a front end thereof.

In a preferred embodiment, the socket body may include a groove into which the elastic body is inserted, and a depth of the groove may be smaller than a sum of a diameter of the elastic body and a width of the curved portion.

In a preferred embodiment, the inner extension portion may further include a second protrusion protruding from a position corresponding to a height of the stopper member.

In a preferred embodiment, the inclined extension portion may include at an undercut recessed from a lower end of the first contact protrusion.

In a preferred embodiment, the socket body may include: an insulating body provided with the slot, the receiving portions, and the stopper member; and a reinforcing frame provided to surround the insulating body.

In a preferred embodiment, the reinforcing frame may further include a guide block assembled to each end thereof and configured to guide insertion of the memory module, and the socket body may further include an ejection lever rotatably provided at each end of the reinforcing frame and configured to remove the memory module.

According to another aspect of the present disclosure, there is provided a contact provided in a memory module socket, the contact including: a ‘ [symbol] ’ shaped body including an upper part that includes a first contact point configured to be electrically connected to a terminal of a memory module and is configured to be pressed inwards when the terminal of the memory module is inserted, and a lower part that includes a second contact point configured to be electrically connected to a test board for testing the memory module, is formed curved at a predetermined arc angle, and includes a fixing end at a distal end thereof, wherein the fixing end may protrude outwards and may be elastically pressed in contact with a first side of the receiving portion in which the contact is received, and the free end of the upper part of the contact where the first contact point is formed may be elastically pressed in contact with a second side of the receiving portion, so the contact may be fitted and fixed in the receiving portion as the contact is elastically compressed by a structural shape of the body.

In a preferred embodiment, before the terminal of the memory module is inserted, the body of the contact may be in a primary elastically pressed state in which the fixing end and the free end are pressed, and after the terminal of the memory module is inserted, the body of the contact may be in a secondary elastically pressed state in which the fixing end and the first contact point are pressed, so the body of the contact may receive elastic deformation in two steps.

In a preferred embodiment, before the terminal of the memory module is inserted, the body of the contact may be fitted and fixed in the receiving portion as the fixing end and the free end are pressed, and after the terminal of the memory module is inserted, as the upper part where the first contact point is formed is pressed inwards, the free end may be released from a state of being pressed and the first contact point may be pressed in contact with the terminal of the memory module thereby, so the body of the contact may be fitted and fixed in the receiving portion as the fixing end and the first contact point are pressed.

According to still another aspect of the present disclosure, there is provided a memory module socket including: a socket body configured to allow terminals of a memory module to be inserted therein and in which a contact and an elastic body are received; the contact having a ‘ [symbol] ’ shape, the contact including an upper part that includes a first contact point configured to be electrically connected to a terminal of a memory module and is configured to be pressed inwards when the terminal of the memory module is inserted, and a lower part that includes a second contact point configured to be electrically connected to a test board for testing the memory module, is formed curved at a predetermined arc angle, and includes a fixing end at a distal end thereof; and the elastic body configured to elastically support the contact, wherein the fixing end may be elastically pressed in contact with a first side of the receiving portion in which the contact is received, and the free end of the upper part where the first contact point is formed may be elastically pressed in contact with a second side of the receiving portion, and the elastic body may perform a first direction pressing by pressing the lower part in a direction of the second contact point and a second direction pressing by pressing the fixing end outwards in the direction of an inner wall of the receiving portion, so the contact may be fitted and fixed in the receiving portion in an elastically compressed manner.

According to yet another aspect of the present disclosure, there is provided a memory module socket including: a socket body including a slot configured to allow terminals of a memory module to be inserted therein, a plurality of receiving portions symmetrically defined by a plurality of partition walls at opposite sides of the slot, and a stopper member provided under the slot; at least one pair of contacts symmetrically provided in each pair of receiving portions and configured to electrically connect the terminals and pads of a test PCB; and an elastic body having a circular cross-section and inserted into the socket body to elastically support each of the contacts to the socket body, wherein each of the contacts may include: a curved portion surrounding at least a portion of an outer circumferential surface of the elastic body; an outer extension portion extending from an outside of the curved portion; an inner extension portion extending from an inside of the curved portion; an inclined extension portion inclinedly extending from the inner extension portion and including a first contact protrusion configured to make contact with a terminal; and a vertical extension portion vertically extending from the inclined extension portion, and each of the receiving portions may include: a restraining surface configured to restrain an initial movement of an upper front end of the outer extension portion to elastically compress and support the outer extension portion; and a pressing protrusion protruding from a lower end of the restraining surface and configured to support the outer extension portion.

As described above, the memory module socket according to the present disclosure includes the socket body, the contact, and the elastic body. The contact includes the curved portion and the outer extension portion extending outwards from the curved portion and having the protrusion protruding outwards, and the socket body includes the restraining surface for elastically compressing and supporting the outer extension portion by restricting the initial movement of the protrusion. According to the present disclosure having the above-described configuration, a contact force between a terminal of the memory module and a pad of the test PCB can be increased by using the contact having its own elasticity.

In more detail, due to the “ [symbol] ” shape of the contact according to the present disclosure, the path connecting the left first contact point making contact with the terminal of the memory module and the lower second contact point making contact with the pad of the test PCB is close to a linear shape, thereby forming a minimized electrical path. The present disclosure achieves contact tension, fixing, and support with minimized structural changes of the fixing end while maintaining these structural characteristics of the first and second contact points. That is, the shape of the protrusion for fixing and tensioning the fixing end does not deviate greatly from a linear rod shape of the contact, and the shape of the contact body minimizes the asymmetric volume. Thus, the resistance characteristics can be improved and the electrical characteristics can be optimized.

Through organic combination between the elastic body and the shape of the contact, the elastic body presses the contact in two directions, that is, in the direction of the second contact point and in the lateral direction, and increases a fixing force of the fixing end. With this configuration, the use of an additional injection-molded product such as a separate bracket for supporting the lower part of the contact can be eliminated, thereby reducing manufacturing costs and simplifying assembly processes.

The contact is made of a copper alloy material having rigidity and having a predetermined elasticity. The contact is supported and fixed inside the socket body as the fixing end on a first side thereof and the free end on a second side thereof are elastically pressed. When the memory module is inserted into the slot, a means elastically pressed is changed from a fixing end and the free end to the fixing end and the first contact point. With this configuration, the contact condition of the first contact point with the terminal of the memory module can be improved, while improving the function of supporting and fixing the contact.

### BRIEF DESCRIPTION OF THE DRAWINGS

The above and other objectives, features, and other advantages of the present disclosure will be more clearly understood from the following detailed description when taken in conjunction with the accompanying drawings, in which:

FIGS. 1A and 1B are respectively a front view and a side view illustrating a typical memory module;

FIG. 2 is a sectional view illustrating a memory module test socket according to the related art;

FIG. 3 is a view illustrating a contact illustrated in FIG. 2;

FIGS. 4A and 4B are perspective views illustrating a memory module socket according to an embodiment of the present disclosure viewed from the top and bottom, respectively;

FIG. 5 is an exploded perspective view illustrating the memory module socket according to the embodiment of the present disclosure;

FIG. 6 is a sectional view taken along line A-A in FIG. 4A;

FIG. 7 is a front view illustrating a contact for the memory module socket according to the embodiment of the present disclosure;

FIG. 8 is a front view illustrating a contact for a memory module socket according to another embodiment of the present disclosure;

FIG. 9 is a sectional view illustrating the memory module socket according to the other embodiment of the present disclosure;

FIGS. 10A and 10B are views illustrating the contact according to the embodiment of the present disclosure and a contact according to the related art, respectively, which are used as simulation test subjects for a memory module socket;

FIGS. 11A and 11B are graphs illustrating simulation test results for the contacts illustrated in FIGS. 10A and 10B; and

FIG. 12 is a sectional view illustrating a memory module socket according to still another embodiment of the present disclosure.

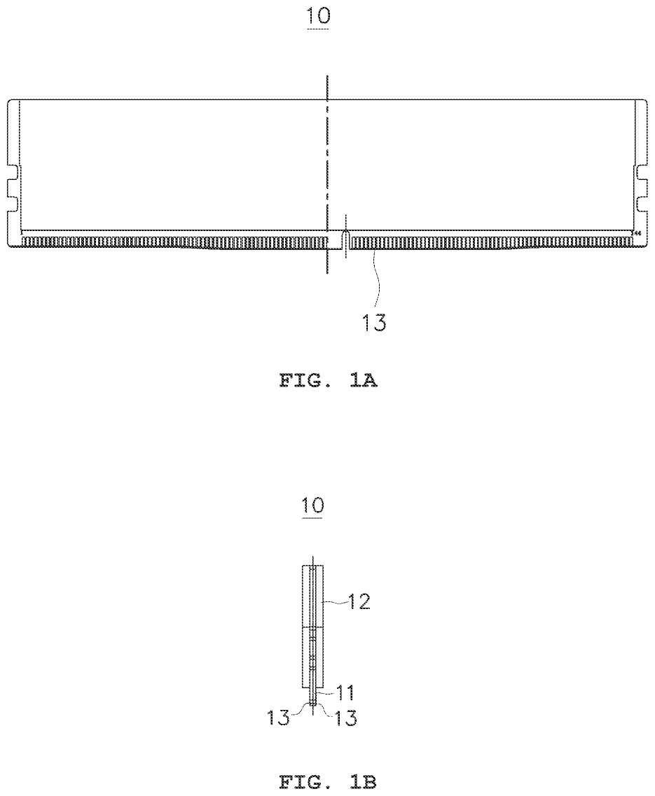

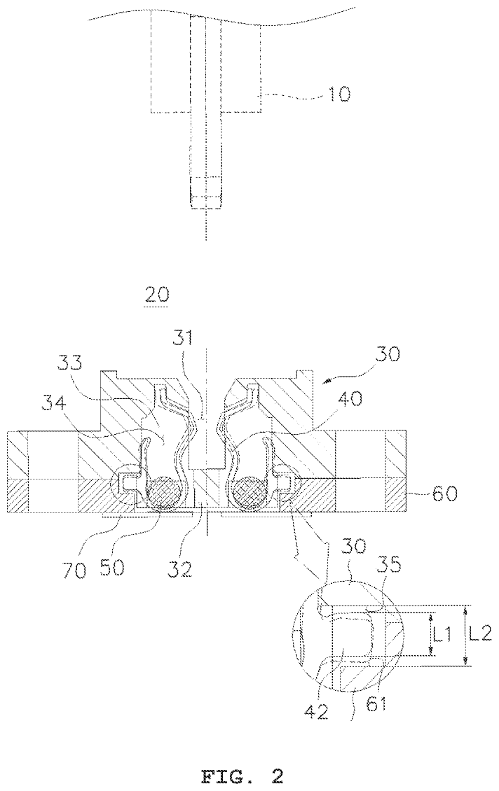

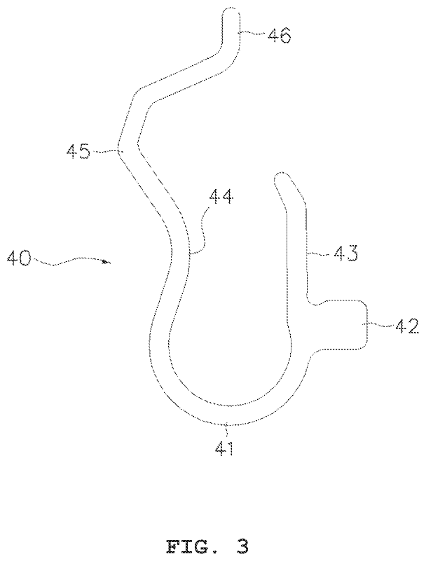

### DETAILED DESCRIPTION OF THE INVENTION

All terms or words used in the specification and claims have the same meaning as commonly understood by one of ordinary skill in the art to which inventive concepts belong. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Specific structural and functional descriptions of embodiments of the present disclosure disclosed herein are only for illustrative purposes of the preferred embodiments of the present disclosure, and the present description is not intended to represent all of the technical spirit of the present disclosure. On the contrary, the present disclosure is intended to cover not only the exemplary embodiments, but also various alternatives, modifications, equivalents, and other embodiments that may be included within the spirit and scope of the present disclosure as defined by the appended claims.

It will be understood that, although the terms “first,”, “second”, “third”, etc. may be used herein to describe various elements, these elements should not be limited by these terms. These terms are only used to distinguish one element from another element. It will be further understood that the directional terms, such as “upper”, “lower”, “left”, “right”, and the like, may be used herein to describe a general positional relationship between the components illustrated in the drawings and are not intended to be limiting.

Hereinafter, exemplary embodiments of the present disclosure will be described in detail with reference to the accompanying drawings. Throughout the drawings, the same reference numerals will refer to the same or like parts.

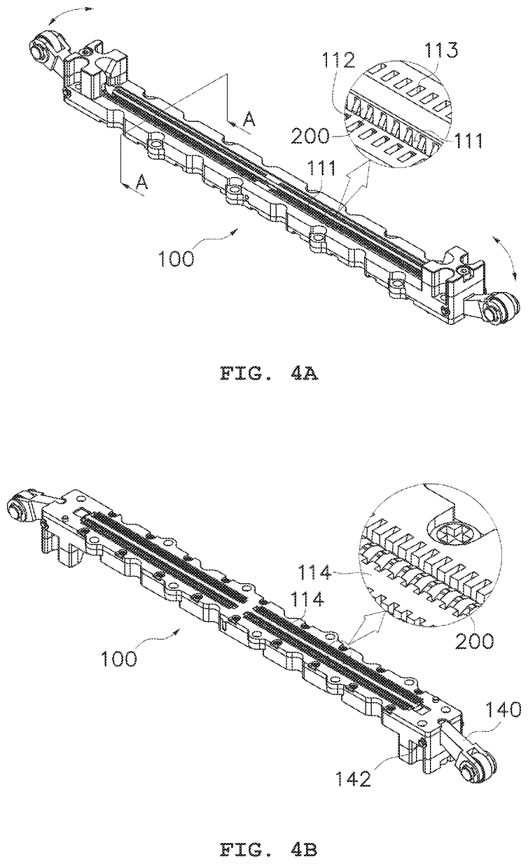

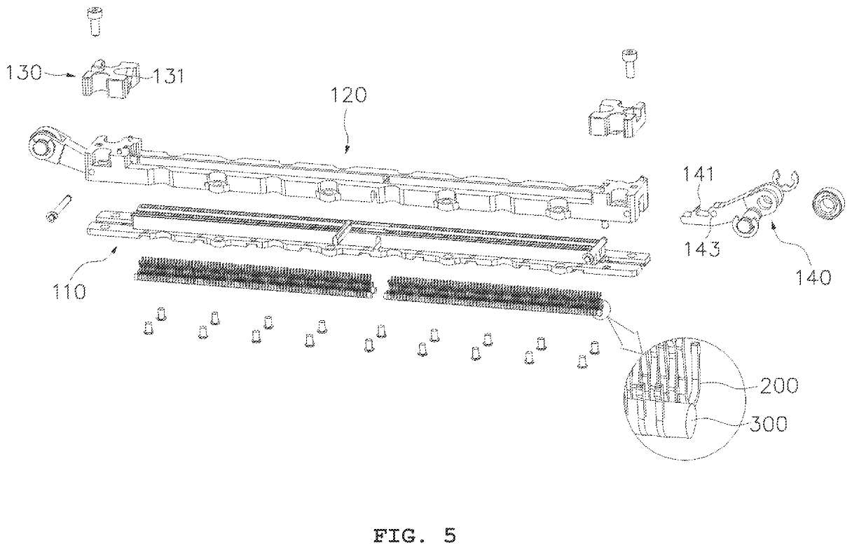

FIGS. 4A and 4B are perspective views illustrating a memory module socket according to an embodiment of the present disclosure viewed from the top and bottom, respectively. FIG. 5 is an exploded perspective view illustrating the memory module socket according to the embodiment of the present disclosure.

Referring to FIGS. 4A, 4B, and 5, the memory module socket according to this embodiment includes a socket body 100, a contact 200, and an elastic body 300.

The socket body 100 includes an insulating body 110 allowing a memory module to be inserted therein, and a reinforcing frame 120 assembled with the insulating body 110. The reinforcing frame 120 is provided to surround the insulating body 110, and may be made of, for example, a metal material such as aluminum.

The reinforcing frame 120 further includes a guide block 130 assembled to each end thereof to guide insertion of the memory module. The guide block 130 is provided with a guide surface 131 so that each end of the memory module is guided by the guide surface 131 of the guide block 130 and inserted into the insulating body 110. Preferably, the socket body 110 further includes an ejection lever 140 rotatably provided at each end of the reinforcing frame 120 to remove the memory module. The ejection lever 140 is provided with an ejection protrusion 141 at one end thereof and a hinge hole 143 hingedly assembled with the reinforcing frame 143 by a hinge pin 142. The insulating body 110 includes a slot 111 allowing the memory module to be inserted therein, and a stopper member 114 provided under the slot 111 and limiting an insertion depth of the memory module. The insulating body 110 is provided with a plurality of contacts 200 symmetrically provided at opposite sides of the slot 111 and making elastic contact with terminals 13 of the memory module. The insulating body 110 has a plurality of receiving portions 113 symmetrically defined by a plurality of partition walls 112 provided at each side of the slot 111. The contacts 200 are received in the respective receiving portions 113.

The insulating body 110 has a groove 115 recessed from a lower end of each of the partition walls 112 and disposed in a longitudinal direction of the insulating body 110. The elastic body 300 is inserted into the respective grooves 115 provided at each side of the slot 111 to support and be in contact with respective lower ends of the contacts 200 provided at each side of the slot 111. The elastic body 300 is made of a material having elasticity such as rubber having a substantially circular cross-section.

Each of the contacts 200 is configured as a strip made of a conductive material such as a copper alloy material having a predetermined thickness. The contacts 200 are symmetrically provided in the receiving portions 113 of the insulating body 110 at opposite sides of the slot 111 to be in contact with the respective elastic bodies 200 so that when the terminals 13 of the memory module are inserted into the slot 13, the contacts 200 make elastic contact with the terminals 13. In particular, the contact 200 according to the present disclosure has a characteristic shape in order to provide a socket capable of repeatedly using a higher-speed signal and a larger current flow required by a high-speed memory module (e.g., DDR5). This will be described below in detail with reference to the related drawings.

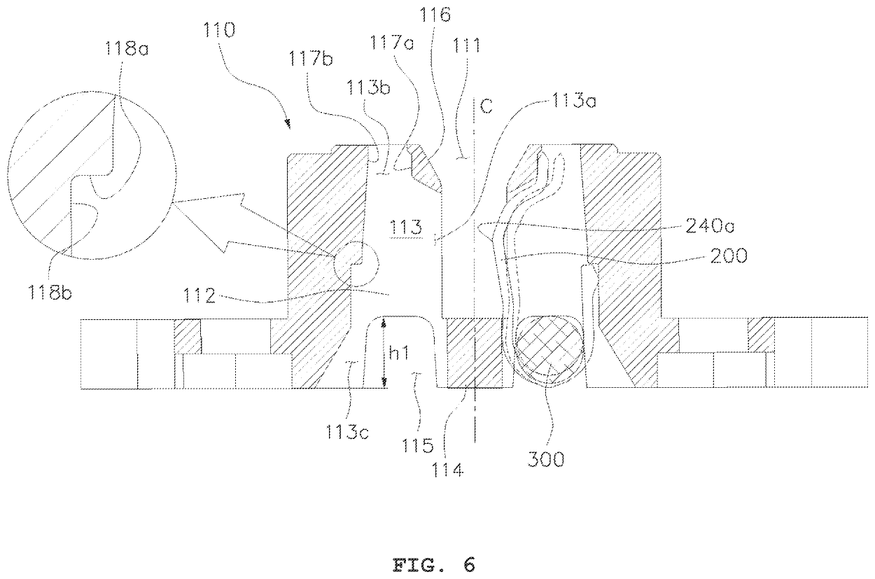

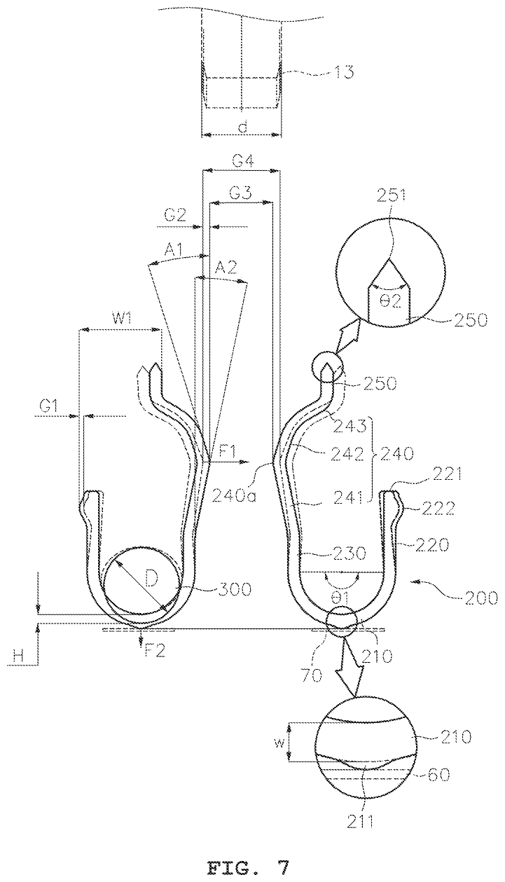

FIG. 6 is a sectional view taken along line A-A in FIG. 4A, and FIG. 7 is a front view illustrating the contact 200 for the memory module socket according to the embodiment of the present disclosure. In FIG. 6, the contact 200 and the elastic body 300 are illustrated only on the right side for better understanding.

As illustrated in FIGS. 6 and 7, the insulating body 110 has the slot 111 formed longitudinally, and the stopper member 114 is provided under the slot 111. The receiving portions 113 are symmetrically defined by the partition walls 112 at opposite sides of the slot 111 so that the contact 200 is disposed in each of the receiving portions 113. The groove 115 having a predetermined depth h1 is recessed from the lower end of each of the partition walls 112, and the elastic body 300 is inserted into the groove 115.

Each of the receiving portions 113 of the insulating body 110 includes a first window 113a opened toward a center C, a second window 113b opened upwards, and a third window 113c opened downwards.

The first window 113a communicates with the slot 111. When a first contact protrusion 240a of the contact 200 protrudes toward the center C through the first window 113a and the memory module is inserted, the first contact protrusion 240a makes contact with a terminal 13 of the memory module. The insulating body 110 has a guide inclined surface 116 for guiding an insertion direction of the memory module into the slot 111 from an upper end of the first window 113a.

The second window 113b is opened upwards of the receiving portion 113. A first restraining surface 117a constituting the second window 113b restrains an upper end of the contact 200 in contact with the upper end of the contact 200. A second restraining surface 117b constituting the second window 113b restrains the upper end of the contact 200 to be elastically displaced excessively outwards of the center C. The insulating body 110 includes a third restraining surface 118a extending stepwise downwards from the second restraining surface 117b and a fourth restraining surface 118b extending from the third restraining surface 118a.

The third window 113c is opened downwards of the receiving portion 113, and includes the groove 115 recessed from the lower end of the partition wall 112.

Each of the contacts 200 includes: a curved portion 210 having a predetermined arc angle Θ1 and surrounding at least a portion of an outer circumferential surface of the elastic body 300; an outer extension portion 220 extending from the outside of the curved portion 210; a first protrusion 222 protruding outwards adjacent to an upper front end 221 of the outer extension portion 220; an inner extension portion 230 extending from the inside of the curved portion 210; an inclined extension portion 240 inclinedly extending from the inner extension portion 230 and having the first contact protrusion 240a making contact with the terminal 13 of the memory module; and a vertical extension portion 250 extending vertically from the inclined extension portion 240 and having a tip portion 251 at a front end thereof.

The curved portion 210 is a portion having the predetermined arc angle Θ1 and in contact with the elastic body 200 having a circular cross-section. The curved portion 210 may have a radius of curvature approximately equal to the radius of the elastic body 200. The arc angle Θ1 of the curved portion 210 may be around 180°. Preferably, a second contact protrusion 211 is formed in a curved surface shape at a lower end of the curved portion 210 to make contact with a pad 70 of a test PCB with a predetermined contact force.

The outer extension portion 220 and the inner extension portion 230 are portions extending vertically from the outside and the inside of the curved portion 210, respectively, and extend in substantially tangent directions from opposite ends of the curved portion 210. Meanwhile, it is to be noted that the terms “inside” and “outside” used in describing the contact 200 are defined as relative directions with respect to the center C of the insulating body 110, and for example, the “inside” of the curved portion 210 represents a position relatively adjacent to the center C of the insulating body 110.

The outer extension portion 220 is provided with the first protrusion 222 protruding outwards adjacent to the upper front end 221. The first protrusion 222 has a substantially half-moon shape. The first protrusion 222 is restrained in lateral and upward directions in contact with the third restraining surface 118a and the fourth restraining surface 118b of the insulating body 110 so that an initial movement of the first protrusion 222 is limited. In this embodiment, the third restraining surface 118a and the fourth restraining surface 118b are illustrated as being two flat surfaces forming a right angle, but the present disclosure is not limited thereto. For example, depending on the shape of the first protrusion 222, the third constraining surface 118a and the fourth constraining surface 118b may be curved surfaces or flat surfaces forming an acute angle (<90°) within a range capable of restricting the initial movement of the first protrusion 222.

The inclined extension portion 240 is a portion providing the first contact protrusion 240a making contact with the terminal 13 of the memory module. The inclined extension portion 240 includes: a first inclined extension portion 241; a second inclined extension portion 242 inclinedly extending from the first inclined extension portion 241 outwards of the center C and having the first contact protrusion 240a at a position connected to the first inclined extension portion 241; and a third inclined extension portion 243 inclinedly extending from the second inclined extension portion 242 outwards of the center C at a steeper inclination than the second inclined extension portion 242.

The vertical extension portion 250 is a portion extending vertically from the third inclined extension portion 243, and is substantially parallel to the direction of the slot 111. The vertical extension portion 250 has the tip portion 251 at the front end thereof. The tip portion 251 is to improve the electrical characteristics of the socket. Therefore, it is preferable that an angle 82 of the tip portion 251 is small.

The vertical extension portion 250 is located in the second window 113b of the receiving portion 113. The vertical extension portion 250 is restricted from moving inwards of the center C by the first restraining surface 117a and is restricted from moving outwards of the center C by the second restraining surface 117b so that an excessive elastic displacement of the vertical extension portion 250 is prevented.

The operation of the contact of the memory module socket configured as described above will be described. The first protrusion 222 of each of a pair of contacts 200 is restrained from initially moving by being supported on the third and fourth restraining surfaces 118a and 118b, so the outer extension portion 220 is in a state of being compressed by a predetermined distance G1. The vertical extension portion 250 is supported on the first restraining surface 117a of the insulating body 110, so a distance G3 between the respective first contact protrusions 240a of the pair of contacts 200 remains smaller than a distance d between terminals 13 of the memory module (G3<d) in a state before the memory module is inserted.

The contact 200 according to this embodiment will be described in more detail.

The contact 200 includes a ‘ [symbol] ’ shaped body. The ‘ [symbol] ’ shaped body includes an upper part and a lower part. The upper part has a first contact point electrically connected to the terminal 13 of the memory module and is pressed inwards when the terminal 13 of the memory module is inserted. The lower part has a second contact point electrically connected to a test board for testing the memory module, is formed curved at a predetermined arc angle, and has a fixing end at a distal end thereof.

Here, the first contact point refers to a point where the above-described first contact protrusion 240a is formed. The second contact point refers to a point where the above-described second contact protrusion 211 is formed. The upper part of the contact 200 where the first contact point is formed may refer a region where the above-described first inclined extension portion 241, second inclined extension portion 242, third inclined extension portion 243, and vertical extension portion 250 are formed. In this embodiment, the upper part is intended to refer to an upper region of the contact 200 formed above the first contact point, and is not intended to necessarily include the first inclined extension portion 241, the second inclined extension portion 242, the third inclined extension portion 243, and the vertical extension portion 250. The vertical extension portion 250 constitutes the upper end the upper part, and is pressed and moved inwards by a predetermined distance when the terminal 13 of the memory module is inserted. Hereinafter, the vertical extension portion 250 is referred to as an upper free end.

The lower part of the contact 200 where the second contact point is formed may refer to a region where the curved portion 210 having the second contact protrusion 211, the outer extension portion 220, and the first protrusion 222 are formed. In this embodiment, the lower part is intended to refer to a lower region of the contact 200 formed below the second contact point, and is not intended to necessarily include the curved portion 210, the outer extension portion 220, and the first protrusion 222. The first protrusion 222 is a fixing means for fixing the contact 200 by elastic pressure in contact with the restraining surfaces 118a and 118b of the receiving portion 113. Hereinafter, the first protrusion 222 is referred to as a lower fixing end.

The contact 200 according to this embodiment has a ‘ [symbol] ’ shaped body, and may be manufactured by punching a metal plate made of material such as a copper alloy. The shape of the body of the contact 200 is a substantially “U” shape with bent portions for providing the contact points. Here, it is to be noted that the lower fixing end of the contact 200 is implemented to have a very small volume without significantly impairing the “U” shape. The shape of the body of the contact 200 configured to have a substantially constant width will be suitable for testing future memory modules that will have ultra-high frequency and ultra-high speed.

In more detail, configuring the contact 200 to have a constant width and a minimized volume in this embodiment is due to the structural change of the fixing end, which is the fixing means of the contact 200. The fixing end of the contact 200 protrudes outwards and is elastically pressed in contact with a first side of the receiving portion 113 in which the contact 200 is received, and the free end of the upper part of the contact 200 where the first contact point is formed is elastically pressed in contact with a second side of the receiving portion 113. Thus, the contact 200 is fitted and fixed in the receiving portion 113 as it is elastically compressed by the structural shape of the body.

The fixing end may be the fixing protrusion 222. The fixing protrusion 222 is in contact with the fourth restraining surface 118b which defines the first side of the receiving portion 113. Here, the fixing protrusion 222 is elastically pressed in contact with the fourth restraining surface 118b defining the first side of the receiving portion 113 as the vertical extension portion 250 serving as the free end is in contact with the first restraining surface 117a which defines the second side of the receiving portion 113. In another embodiment, the fixing end may be pressed by protruding the fourth restraining surface 118b defining the first side of the receiving portion 113 in contact with the fixing end, rather than protruding the fixing end. In this case, the fixing end may have a stepped portion so that the fixing end is fixedly supported on the protruding area of the fourth restraining surface 118b. Meanwhile, as the free end and the fixing end are in simultaneous contact with the first side and the second side of the receiving portion 113, the body of the contact 200 is fitted and fixed in the receiving portion 113 by being pressed by a reaction force against an extension elastic force of the contact 200.

Here, the above-described state in which the fixing end and the free end are pressed before the terminal 13 of the memory module is inserted is referred to as a primary elastically pressed state. The contact 200 according to this embodiment is made of a rigid material having a predetermined elasticity. After the terminal 13 of the memory module is inserted into the contact 200, a secondary elastically pressed state in which the fixing end and the first contact point are pressed may be formed.

As described above, the contact 200 according to this embodiment is fixed and supported in an elastically compressed manner. Here, it is to be noted that a means for fixing and supporting the contact 200 is changed depending on before and after inserting the terminal 13 of the memory module.

That is, in the primary elastically pressed state, the body of the contact 200 is fixed by the vertical extension portion 250 serving as the free end and the fixing protrusion 222 serving as the fixing end. On the other hand, in the secondary elastically pressed state in which the terminal 13 of the memory module is inserted, as the vertical extension portion 250 serving as the free end moves inwards, it is separated from the first restraining surface 117a and the fixing of the free end is released thereby. At the same time, the first contact protrusion 240a serving as the first contact point comes into contact with the inserted terminal 13 of the memory module. Thus, the first contact protrusion 240a is elastically pressed instead of the previously elastically pressed free end and pressed and moved inwards by a distance corresponding to the extent that the free end is elastically pressed. As result, the contact elastic pressing of the terminal 13 of the memory module and the first contact protrusion 240a replaces the pressing of the free end, so the means for fixing and supporting the contact 200 is changed to the first contact protrusion 240a and the fixing protrusion 222. As the means for supporting the body of the contact 200 is changed to the first contact protrusion 240a in the secondary elastically pressed state, the contact condition of the first contact point is improved.

In the contact 200 according to this embodiment, the contact condition of the second contact point is improved, as well as the above-described first contact point. The elastic body 300 is a means for pressing the contact 200 in the direction of the second contact point. In one embodiment, the elastic body 300 may be a cylindrical ring having a length and made of a rubber material. The length of the elastic body 300 may correspond to the length of the slot 111. Thus, one elastic body 300 is inserted into the respective grooves 115 provided at each side of the slot 111 so that the contacts 200 provided at each side of the slot 111 are elastically pressed simultaneously.

The elastic body 200 is supported through the curved portion 210 defining the lower part of the contact 200. The curved portion 210 of the contact 200 is exposed to the outside and makes contact with the test board. Upon contact with the test board, the curved portion 210 is pressed upwards, and the elastic body 300 provides a reaction force against the pressing force exerted on the curved portion 210 to press the curved portion 210 in the direction of the second contact point, that is, the test board. Here, the pressing force is concentrated on the second contact protrusion 211 formed on the curved portion 210, so a reliable electrical contact with the test board is formed.

It is to be noted that the elastic body 200 according to this embodiment applies an elastic force in two directions. In detail, the elastic body 300 may perform a first direction pressing by pressing the lower part of the contact 200 in the direction of the second contact point as described above and a second direction pressing by pressing the fixing end of the contact 200 outwards in the direction of an inner wall of the receiving portion 113.

The pressing of the elastic body 300 in the second direction causes the fixing protrusion 222 serving as the fixing end to be pressed in the direction of the fourth restraining surface 118b to assist the extension elastic force of the contact 200. By organically combining the shape of the contact 200 and the elastic body 200, three functions of fitting fixing, improvement of the first contact point's contact condition, improvement of the second contact point's contact condition are achieved.

Preferably, a depth h1 of the groove 115 into which the elastic body 300 is inserted is smaller than the sum of a diameter D of the elastic body 300 and a width w of the curved portion 210 (h1<D+w). Thus, the second contact protrusion 211 formed in a curved surface shape at the lower end of the curved portion 210 comes into contact with the pad 70 of the test PCB with a predetermined contact force F2 corresponding to a compressed length H of the elastic body 300.

Meanwhile, when the memory module is inserted into the slot 111, the first contact protrusions 240a of the pair of contacts 200 are opened outwards. At this time, as the first contact protrusions 240a are opened by a distance G4 (i.e., G4=d), a compressive force is exerted on the respective inclined extension portions 240, so each of the first contact protrusions 240a comes into contact with the terminal 13 of the memory module with a predetermined contact force F1. Here, the magnitude of the contact force F1 is proportional to a compression distance G1 of the first protrusion 222 and a compression distance G2 of the first contact protrusion 240a. Preferably, the first protrusion 222 is provided at least higher than the elastic body 300 and lower than the first contact protrusion 240a. Thus, the length of the outer extension portion 220 is appropriately determined in consideration of the position of the first protrusion 222.

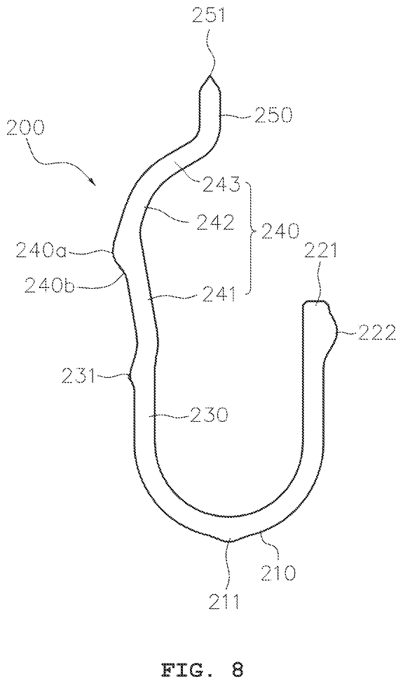

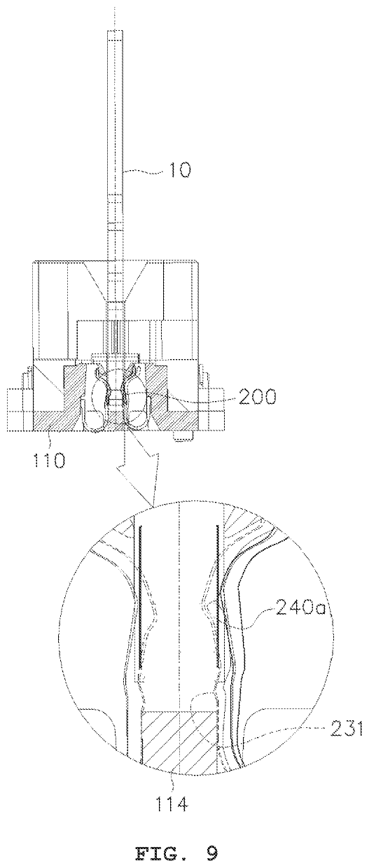

FIG. 8 is a front view illustrating a contact 200 for a memory module socket according to another embodiment of the present disclosure, and FIG. 9 is a sectional view illustrating the memory module socket according to the other embodiment of the present disclosure. In the description below, the same reference numerals will be used for parts that are the same as in the previous embodiment, and any redundant descriptions will be omitted.

Referring to FIGS. 8 and 9, in the contact 200 according to this embodiment, an inner extension portion 230 further includes a second protrusion 231. Preferably, the second protrusion 231 protrudes from a position corresponding to the height of a stopper member 114.

Preferably, an inclined extension portion 240 has an undercut 240b recessed from a lower end of a first contact protrusion 240a. The first contact protrusion 240a tends to be worn out and flattened as it repeatedly makes contact with a terminal of a memory module, resulting in electrical contact failure. The undercut 240b formed at the lower end of the first contact protrusion 240a reduces such contact failure.

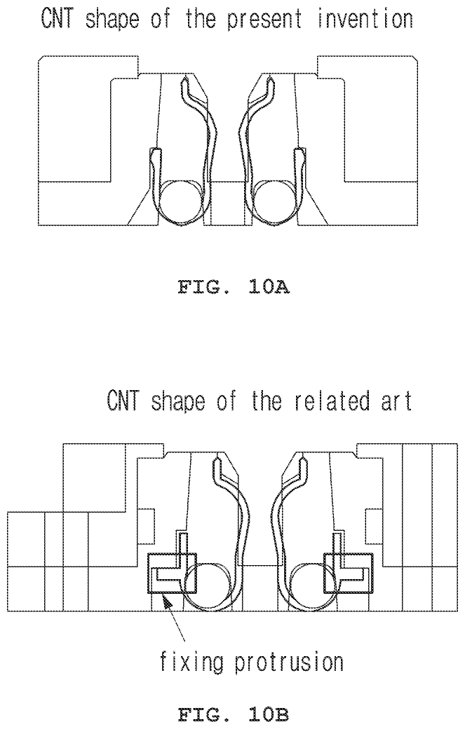

FIGS. 10A and 10B are views illustrating the contact according to the embodiment of the present disclosure and a contact according to the related art, respectively, which are used as simulation test subjects for a memory module socket. In this experimental example, a simulation test was conducted to compare and evaluate the performance of Insertion Loss at the input and Return Loss at the output, which may act as obstacles to the flow of signal, to evaluate the performance of the contacts.

Referring to FIGS. 10A and 10B, the contact according to the present disclosure corresponding to the embodiment illustrated in FIGS. 6 and 7 and the contact according to the related art disclosed in Korean Patent No. 10-0887936 were compared.

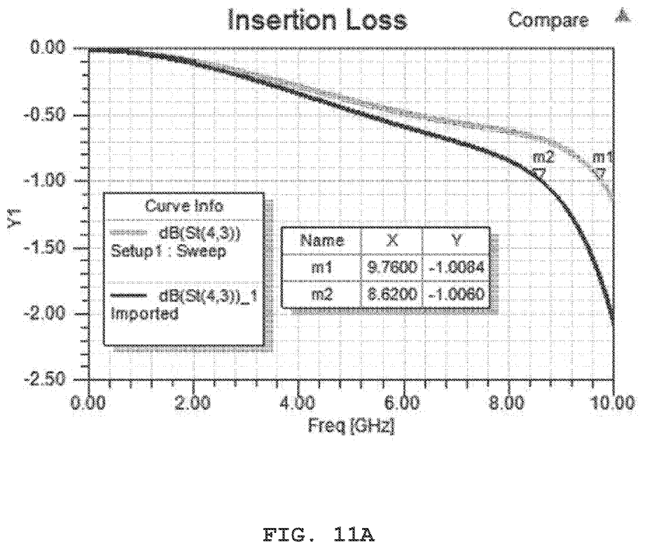

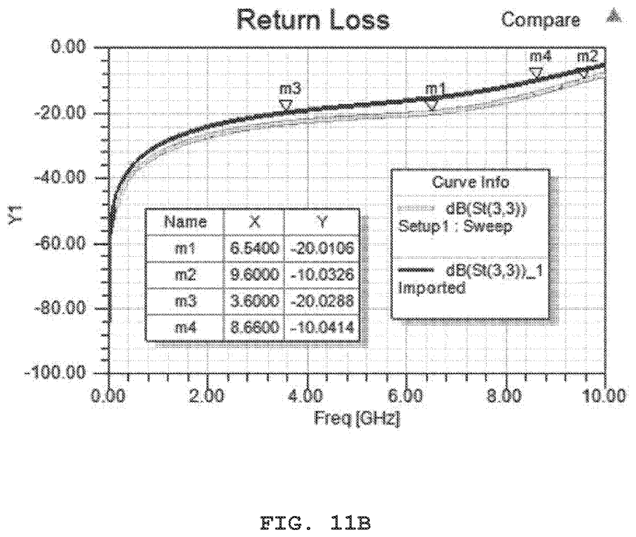

FIGS. 11A and 11B are graphs illustrating simulation test results for the contacts illustrated in FIGS. 10A and 10B.

FIG. 11A illustrates Insertion Loss simulation results of the contacts, and FIG. 11B illustrates Return Loss simulation results of the contacts. In the graphs of FIGS. 11A and 11B, the red profile represents the contact performance data of the present disclosure illustrated in FIG. 10A, and the blue profile represents the contact performance data of the related art illustrated in FIG. 10B. The x-axis is the frequency of test signal, and the y-axis is the value of each Loss in units of dB.

Referring to FIG. 11A, as a result of comparing points m2 and m1 where the Insertion Loss is −1 dB, it can be found that the frequency band is improved from 8.62 Gb to 9.76 Gb. At −1 dB, the frequency characteristics are improved by about 12%, indicating better high frequency characteristics. These high-frequency characteristics began to appear significantly from an Insertion Loss of about −0.5 dB. While the Insertion Loss of the contact according to the embodiment of the present disclosure is only −1.3 dB up to an ultra-high frequency band in the range of 10 GHz, the Insertion Loss of the contact according to the related art rapidly decreases as it goes toward the ultra-high frequency band.

Referring to FIG. 11B, as a result of comparing points m4 and m2 where the Return Loss is −10 dB, it can be found that the frequency band is improved from 8.66 Gb to 9.6 Gb. At −10 dB, the frequency characteristics are improved by about 11%, indicating better high frequency characteristics. In addition, as a result of comparing points m3 and m1 where the Return Loss is −20 dB, it can be found that the frequency band is improved from 3.6 Gb to 6.54 Gb. At −20 dB, the frequency characteristics are improved by about 81%, indicating better high frequency characteristics.

These high-frequency characteristics began to appear significantly from a Return Loss of about −40 dB. The high-frequency characteristics are more improved than in the case of the Insertion Loss at the same Return Loss level compared to the contact according to the related art.

The simulation results of FIG. 11 confirm that an irregular shape of the contact and a slight difference in volume have an influence on the test characteristics and this influence becomes more significant in the ultra-high frequency band. In the case of the related art, a fixing protrusion for fixing the contact resulted in an irregular shape, and this shape may act as an obstacle to the flow of signal and increase Insertion Loss noise. In addition, since the conventional fixing protrusion has a closed structure in which a test signal tends to be reflected back to the input, Return Loss noise may be further increased.

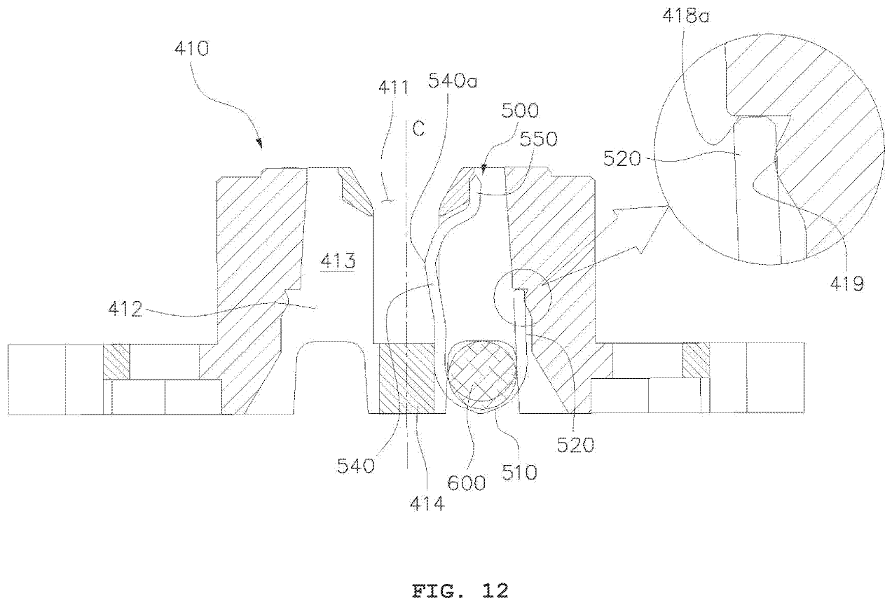

FIG. 12 is a sectional view illustrating a memory module socket according to still another embodiment of the present disclosure in which a contact 500 and an elastic body 600 are illustrated only on the right side. In this embodiment, descriptions overlapping with the previous embodiment will be omitted, and differences will be mainly described.

Referring to FIG. 12, the memory module socket according to this embodiment includes an insulating body 410, the contact 500, and the elastic body 600.

The contact 500 includes: a curved portion 510 surrounding at least a portion of an outer circumferential surface of the elastic body 600; an outer extension portion 520 extending from the outside of the curved portion 510; an inner extension portion 530 extending from the inside of the curved portion 510; an inclined extension portion 540 inclinedly extending from the inner extension portion 530 and having a first contact protrusion 540a making contact with a terminal; and a vertical extension portion 550 vertically extending from the inclined extension portion 540.

The insulating body 410 includes a slot 411 allowing terminals of a memory module to be inserted therein, a plurality of receiving portions 413 symmetrically defined by a plurality of partition walls 412 at opposite sides of the slot 411, and a stopper member 414 provided under the slot 411. Each of the receiving portions 413 of the insulating body 410 includes a restraining surface 418a for restricting an initial movement of a front end of the outer extension portion 520, and a pressing protrusion 419. The restraining surface 418a of the receiving portion 413 is formed stepwise substantially horizontally to restrain the outer extension portion 520 from moving in a vertical direction. The pressing protrusion 419 protrudes horizontally from an approximate lower end of the restraining surface 418a to elastically support the outer extension portion 220 in a horizontal direction and provide an initial compressive force to the outer extension portion 220.

Although preferred embodiments of the present disclosure have been described for illustrative purposes, those skilled in the art will appreciate that various modifications, additions, and substitutions are possible, without departing from the scope and spirit of the present disclosure as disclosed in the accompanying claims.

What is claimed is:

1. A memory module socket comprising:
a socket body comprising a slot configured to allow terminals of a memory module to be inserted therein, a plurality of receiving portions symmetrically defined by a plurality of partition walls at opposite sides of the slot, and a stopper member provided under the slot;
at least one pair of contacts symmetrically provided in each pair of receiving portions and configured to electrically connect the terminals and pads of a test PCB; and
an elastic body having a circular cross-section and inserted into the socket body to elastically support each of the contacts to the socket body,
wherein each of the contacts comprises:
a curved portion surrounding at least a portion of an outer circumferential surface of the elastic body;
an outer extension portion extending from an outside of the curved portion;
a first protrusion protruding outwards adjacent to an upper front end of the outer extension portion;
an inner extension portion extending from an inside of the curved portion;
an inclined extension portion inclinedly extending from the inner extension portion and comprising a first contact protrusion configured to make contact with a terminal; and a vertical extension portion vertically extending from the inclined extension portion, and
each of the receiving portions comprises restraining surfaces configured to restrain an initial movement of the first protrusion to elastically compress and support the outer extension portion.

2. The memory module socket of claim 1, wherein the curved portion comprises a second contact protrusion formed in a curved surface shape at a lower end thereof.

3. The memory module socket of claim 1, wherein the vertical extension portion comprises a tip portion at a front end thereof.

4. The memory module socket of claim 1, wherein the socket body comprises a groove into which the elastic body is inserted, and a depth of the groove is smaller than a sum of a diameter of the elastic body and a width of the curved portion.

5. The memory module socket of claim 1, wherein the inner extension portion further comprises a second protrusion protruding from a position corresponding to a height of the stopper member.

6. The memory module socket of claim 1, wherein the inclined extension portion comprises at an undercut recessed from a lower end of the first contact protrusion.

7. The memory module socket of claim 1, wherein the socket body comprises:
an insulating body provided with the slot, the receiving portions, and the stopper member; and
a reinforcing frame provided to surround the insulating body.

8. The memory module socket of claim 7, wherein the reinforcing frame further comprises a guide block assembled to each end thereof and configured to guide insertion of the memory module.

9. The memory module socket of claim 7, wherein the socket body further comprises an ejection lever rotatably provided at each end of the reinforcing frame and configured to remove the memory module.

10. A contact provided in a memory module socket, the contact comprising:
a ‘ [symbol] ’ shaped body comprising an upper part that comprises a first contact point configured to be electrically connected to a terminal of a memory module and is configured to be pressed inwards when the terminal of the memory module is inserted, and a lower part that comprises a second contact point configured to be electrically connected to a test board for testing the memory module, is formed curved at a predetermined arc angle, and comprises a fixing end at a distal end thereof,
wherein the fixing end protrudes outwards and is elastically pressed in contact with a first side of the receiving portion in which the contact is received, and the free end of the upper part of the contact where the first contact point is formed is elastically pressed in contact with a second side of the receiving portion, so the contact is fitted and fixed in the receiving portion as the contact is elastically compressed by a structural shape of the body.

11. The contact of claim 10, wherein before the terminal of the memory module is inserted, the body of the contact is in a primary elastically pressed state in which the fixing end and the free end are pressed, and
after the terminal of the memory module is inserted, the body of the contact is in a secondary elastically pressed state in which the fixing end and the first contact point are pressed, so the body of the contact receives elastic deformation in two steps.

12. The contact of claim 10, wherein before the terminal of the memory module is inserted, the body of the contact is fitted and fixed in the receiving portion as the fixing end and the free end are pressed, and
after the terminal of the memory module is inserted, as the upper part where the first contact point is formed is pressed inwards, the free end is released from a state of being pressed and the first contact point is pressed in contact with the terminal of the memory module thereby, so the body of the contact is fitted and fixed in the receiving portion as the fixing end and the first contact point are pressed.

13. A memory module socket comprising:
a socket body configured to allow terminals of a memory module to be inserted therein and in which a contact and an elastic body are received;
the contact having a ‘ [symbol] ’ shape, the contact comprising an upper part that comprises a first contact point configured to be electrically connected to a terminal of a memory module and is configured to be pressed inwards when the terminal of the memory module is inserted, and a lower part that comprises a second contact point configured to be electrically connected to a test board for testing the memory module, is formed curved at a predetermined arc angle, and comprises a fixing end at a distal end thereof; and
the elastic body configured to elastically support the contact,
wherein the fixing end is elastically pressed in contact with a first side of the receiving portion in which the contact is received, and the free end of the upper part where the first contact point is formed is elastically pressed in contact with a second side of the receiving portion, and
the elastic body performs a first direction pressing by pressing the lower part in a direction of the second contact point and a second direction pressing by pressing the fixing end outwards in the direction of an inner wall of the receiving portion, so the contact is fitted and fixed in the receiving portion in an elastically compressed manner.

14. A memory module socket comprising:
a socket body comprising a slot configured to allow terminals of a memory module to be inserted therein, a plurality of receiving portions symmetrically defined by a plurality of partition walls at opposite sides of the slot, and a stopper member provided under the slot;
at least one pair of contacts symmetrically provided in each pair of receiving portions and configured to electrically connect the terminals and pads of a test PCB; and
an elastic body having a circular cross-section and inserted into the socket body to elastically support each of the contacts to the socket body,
wherein each of the contacts comprises:
a curved portion surrounding at least a portion of an outer circumferential surface of the elastic body; an outer extension portion extending from an outside of the curved portion; an inner extension portion extending from an inside of the curved portion; an inclined extension portion inclinedly extending from the inner extension portion and comprising a first contact protrusion configured to make contact with a terminal; and a vertical extension portion vertically extending from the inclined extension portion, and
each of the receiving portions comprises:
a restraining surface configured to restrain an initial movement of an upper front end of the outer extension portion to elastically compress and support the outer extension portion; and
a pressing protrusion protruding from a lower end of the restraining surface and configured to support the outer extension portion.
